(19) United States
(12) Patent Application Publication
(10) Pub. No.: US 2020/0074006 A1
(43) Pub. Date: Mar. 5, 2020

(54) SYSTEM AND METHOD FOR PROVIDING CUSTOMER SPECIFIED WEBPAGE CONFIGURATION

(71) Applicant: Intuit Inc., Mountain View, CA (US)

(72) Inventor: Siddharth Ram, Menlo Park, CA (US)

(73) Assignee: Intuit Inc., Mountain View, CA (US)

(21) Appl. No.: 16/116,636

(22) Filed: Aug. 29, 2018

(51) Int. Cl. G06F 17/30; G06F 15/18; H04L 29/08

(52) U.S. Cl. CPC G06F 17/30867; G06F 15/18; H04L 67/306; G06F 17/3089; H04L 67/2823

(57) ABSTRACT

A method and system provide reduced and personalized versions of webpages to users lacking sufficient computing resources to load the full versions of the webpages in a satisfactorily short amount of time. The method and system receives a request from a user to access a webpage, analyze the computing resources of the user, and determine whether the user is able to load the full version of the webpage quickly. If the user is able to load the full version of the webpage quickly, then the method and system outputs the full version of the webpage to the user. If the user is unlikely able to load the full version of the webpage quickly, then the method and system outputs a reduced version of the webpage retaining the portions most likely to be relevant to the user based on an analysis of user data related to the user.

### BACKGROUND

The performance of a website can vary greatly depending on various factors. When a user accesses a webpage associated with a website via a web browser, data from the website is downloaded to the computing environment of the user. When the data has been downloaded, the web browser displays the webpage to the user.

Some webpages include a large amount of information, such as text, graphics, video, audio, hyperlinks, and software code. In these cases, there is a correspondingly large amount of data that must be downloaded to the computing environment of the user and processed before the webpage can be fully displayed. The amount of time that is required for a webpage to download and be displayed depends, in part, on the quality of the network connection and the processing and memory resources associated with the computing environment of the user. A computing environment with less network bandwidth, greater network latency, and less robust processing and memory resources can take significantly longer to load and render a webpage than a computing environment with better network, processing, and memory resources.

In many cases, users that visit a website can become frustrated if a particular webpage takes a long time to load. The users may abandon the website and seek out other websites that may load more quickly. This poses problems for the operators of the website as they may lose revenue, marketability, and prestige.

Many organizations have expended large amounts of human and computing resources in an effort to host webpages that load more quickly. Nevertheless, these organizations have not been able to overcome the technical challenge of presenting webpages that load quickly for users with more limited computing resources while still maintaining a high level of presentational and informational quality on the webpages.

What is needed is a method and system that provide a technical solution to the long-standing technical problem of providing high-quality webpages that also achieve high performance benchmarks even for users with limited network and processing resources.

### SUMMARY

Embodiments of the present disclosure provide one or more technical solutions to the technical problem of providing high-quality webpages that also achieve high performance benchmarks even for users with limited network and processing resources. When a user accesses a webpage, embodiments of the present disclosure quickly determine the quality of the computing resources, such as network connection and processing resources, associated with the computing environment of the user. If the computing resources are sufficient to load the full webpage in a satisfactory amount of time, embodiments of the present disclosure provide the full webpage to the user. If the computing resources are not sufficient to load the full webpage in a satisfactory amount of time, embodiments of the present disclosure analyze user related data and determine which portions of the webpage are likely to be most relevant to the user. Embodiments of the present disclosure then load a reduced version of the webpage including only the most relevant portions of the webpage, leaving less relevant portions unloaded. The result is that the webpage loads quickly for all users, while maintaining a high-quality experience.

Embodiments of the present disclosure address some of the shortcomings associated with traditional website service providers. The amount of webpage content to be displayed to a user depends on the computing resources of the user. In the event that a reduced amount of content should be displayed, the content to be displayed is chosen based on the characteristics of the user. Therefore, the various described embodiments of the disclosure and their associated benefits amount to significantly more than an abstract idea. In particular, by analyzing the computing resources of the user and the personal characteristics of the user, high quality and relevant webpage data can be displayed to each user while achieving selected webpage loading performance benchmarks. In this way, the effectiveness and efficiency of the website is greatly improved.

### BRIEF DESCRIPTION OF THE DRAWINGS

FIG. 1 is a block diagram of a system for reducing and personalizing the webpage content displayed to users based on the computing resources and personal characteristics of the users, in accordance with one embodiment.

FIG. 2 is a block diagram of a system for reducing and personalizing the webpage content displayed to users based on the computing resources and personal characteristics of the users, in accordance with one embodiment.

FIG. 3 is a block diagram of a process for reducing and personalizing the webpage content displayed to users based on the computing resources and personal characteristics of the users, in accordance with one embodiment.

FIG. 4 is a flow diagram of a process for reducing and personalizing the webpage content displayed to users based on the computing resources and personal characteristics of the users, in accordance with one embodiment.

FIG. 5 is a flow diagram of a process for reducing and personalizing the webpage content displayed to users based on the computing resources and personal characteristics of the users, in accordance with one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

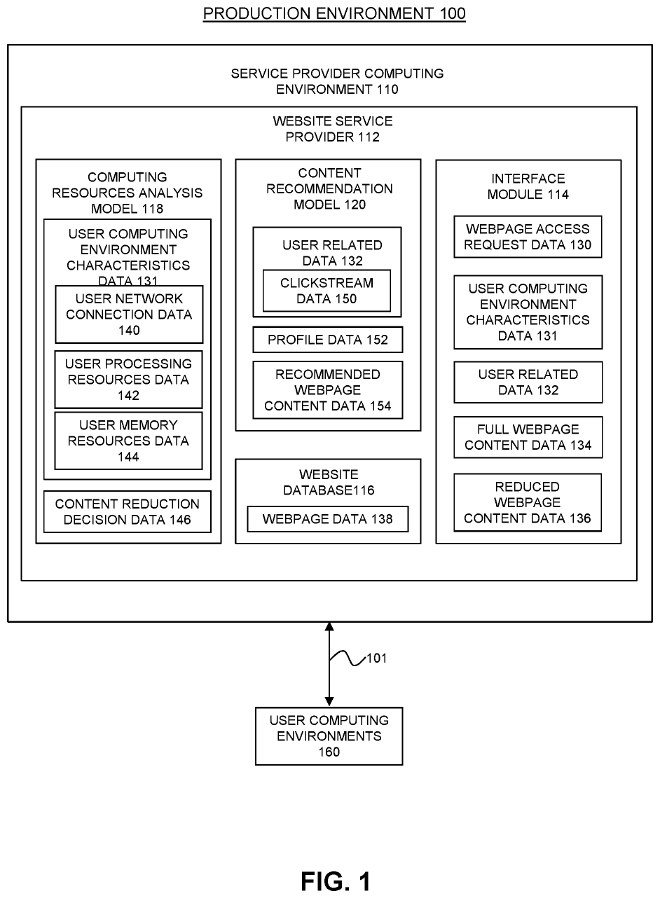

FIG. 1 illustrates a block diagram of a production environment 100 for reducing and personalizing the webpage content displayed to users based on the computing resources and personal characteristics of the users, according to one embodiment. Embodiments of the present disclosure determine whether the full content of a webpage can be loaded in the user computing environment in a selected amount of time by analyzing the characteristics of the user computing environment. If the full content of the webpage can be loaded in the selected amount of time, then embodiments of the present disclosure load the full content of the webpage to the user computing environment. If the full content of the webpage cannot be loaded in the selected amount of time, then embodiments of the present disclosure determine which portions of the webpage should be loaded based on the characteristics of the user. Embodiments of the present disclosure then load a reduced version of the webpage, retaining the content most likely to be relevant to the user.

The disclosed method and system for reducing and personalizing the webpage content displayed to users based on the computing resources and personal characteristics of the users provides for significant improvements to the technical fields of data processing, data transmission, and user experience.

In addition, as discussed above, the disclosed method and system for reducing and personalizing the webpage content displayed to users based on the computing resources and personal characteristics of the users provide for the processing and storage of smaller amounts of data, i.e., more efficiently provide webpage data to users, thereby eliminating unnecessary data analysis and storage. Consequently, using the disclosed method and system for reducing and personalizing the webpage content displayed to users based on the computing resources and personal characteristics of the users results in more efficient use of human and non-human resources, fewer processor cycles being utilized, reduced memory utilization, and less communications bandwidth being utilized to relay data to, and from, backend systems and client systems, and various investigative systems and parties. As a result, computing systems are transformed into faster, more efficient, and more effective computing systems by implementing the method and system for reducing and personalizing the webpage content displayed to users based on the computing resources and personal characteristics of the users.

The production environment 100 includes a service provider computing environment 110 and user computing environments 160, for reducing and personalizing the webpage content displayed to users based on the computing resources and personal characteristics of the users, according to various embodiments. The computing environments 110 and 160 are communicatively coupled to each other with one or more communication channels 101, according to various embodiments.

The service provider computing environment 110 represents one or more computing systems such as one or more servers and/or distribution centers that are configured to receive, execute, and host one or more website service providers (e.g., applications) for access by one or more users, for reducing and personalizing the webpage content displayed to users based on the computing resources and personal characteristics of the users, according to one embodiment. The service provider computing environment 110 represents a traditional data center computing environment, a virtual asset computing environment (e.g., a cloud computing environment), or a hybrid between a traditional data center computing environment and a virtual asset computing environment, according to various embodiments.

The service provider computing environment 110 includes a website service provider 112, which is configured to enable users to access the website supported by the website service provider 112, according to one embodiment.

According to one embodiment, the website service provider 112 supports a website associated with a data management system. The data management system can include an electronic bookkeeping system that assists users in bookkeeping or other financial accounting practices. Additionally, or alternatively, the data management systems can manage one or more of tax return preparation, banking, invoicing, investments, loans, credit cards, real estate investments, retirement planning, bill pay, and budgeting. The website service provider 112 can be a standalone system that provides data management services to users. Alternatively, the website service provider 112 can be integrated into other software or service products provided by a service provider. According to an embodiment, the website service provider 112 can provide one or more websites other than data management system related websites.

In one embodiment, the website service provider 112 includes an interface module 114, a website database 116, a computing resources analysis model 118, and a content recommendation model 120, according to various embodiment.

The user computing environments 160 correspond to computing environments of the various users to access the website or websites associated with the website service provider 112. The users utilize the user computing environments 160 to interact with the websites such as by transmitting data to the websites and receiving data from the websites. Accordingly, the users of the website supported by the website service provider 112 can use the user computing environments 160 to provide data to the website supported by the website service provider 112 and to receive data from the website supported by the website service provider 112.

In one embodiment, users access the website by utilizing a web browser implemented with the user computing environments 160. Examples of web browsers can include any programs or applications utilized by individuals to access websites.

In one embodiment, the website associated with the website service provider 112 can include multiple webpages. Each webpage can have a unique web address, network address, or uniform resource locator (URL). Each webpage can have content associated there with. For typical websites, when the user accesses a particular webpage by entering a URL or by clicking on a hyperlink, the typical web sites load all of the content associated with the webpage in the web browser window currently being operated by the user in the user computing environment.

In one embodiment, a user provides webpage access request data 130 to the website service provider 112 by entering a URL associated with the webpage into the web browser the user, or by selecting a hyperlink from another webpage. Accordingly, the webpage access request data 130 can include a URL or another kind of web address entered by a user into a web browser or another application for accessing webpages.

In one embodiment, the interface module 114 also receives user computing environment characteristics data 131. The user computing environment characteristics data 131 identifies the computing characteristics of the computing environment associated with the user.

In one embodiment, the user computing environment characteristics data 131 can include data related to the network connection of the user. The data related to the network connection of the user can include an identification of the Internet service provider (ISP) currently providing an Internet connection to the user.

In one embodiment, the data related to the network connection can include data identifying the bandwidth associated with the network connection. The bandwidth can correspond to an amount of data per second the network connection is able to download and/or upload. A larger bandwidth is able to download or upload data more quickly. Accordingly, the bandwidth associated with a network can affect how quickly the user can download data associated with the webpage for which the user has provided webpage access request data.

In one embodiment, the data related to the network connections can include network latency data. The network latency data can indicate the latency of the network, such as the magnitude of a delay that happens when data is communicated over the network. A lower latency network can provide faster communication than a higher latency network. Accordingly, the latency associated with a network can affect how quickly the user can download data associated with the webpage for which the user has provided webpage access request data.

In one embodiment, the user computing environment characteristics data 131 can include data related to the processing resources of the user computing environment. For example, if the user requests to access a webpage from a laptop computer, a laptop computer typically has one or more processors associated therewith. The quality of the processer affects how quickly the user computing environment can process and load webpage data downloaded from the website service provider 112. Higher quality processors can process and load webpage data more quickly than can low quality processors. The information related to the processors can include the manufacturer of the processors, the model number of the processors, a number of cores associated with the processors, a clock frequency associated with the processors, or other characteristics of the processors. Accordingly, the quality of the processing resources associated with the user computing environment can affect how quickly the user can download data associated with the webpage for which the user has provided webpage access request data.

In one embodiment, the user computing environment characteristics data 131 can include temperature data associated with the one or more processors of the user computing environment. Processors operating at higher temperatures may be taxed to the point that they cannot quickly process and load new webpage data. Accordingly, the temperature of the processors can affect how quickly the user computing environment can process and load webpage data associated with the webpage that the user is trying to access.

In one embodiment, some details related to the processors set forth above can be extrapolated from more basic information that is collected by the website service provider 112. Thus, the website service provider 112 can receive some information about the processing resources and can extrapolate other information about the processing resources.

In one embodiment, the user computing environment characteristics data 131 can include data related to the memory resources associated with the user computing environment. The data related to the memory resources can include an amount of memory allocated to the web browser. The data related to the memory resources can include an amount of memory currently remaining for use by the web browser. The data related to the memory resources can include amounts of memory associated with the one or more processors. The data related to the memory resources can include amounts of random access memory (RAM) such as static random-access memory (SRAM) or dynamic random-access memory (DRAM). The data related to the memory resources can include an amount is read only memory (ROM) associated with the computing environment of the user. The data related to the memory resources can include access speeds associated with the memory various types of memories included in the computing environments.

As set forth above, some webpages include a large amount of information, such as text, graphics, video, audio, and hyperlinks. In these cases, there is a correspondingly large amount of data that must be downloaded to the computing environment of the user and processed before the webpage can be fully displayed. The amount of time that is required for a webpage to download and be displayed depends, in part, on the quality of the network connection and the processing and memory resources associated with the computing environment of the user. A computing environment with less network bandwidth, greater network latency, and less robust processing and memory resources can take significantly longer to load a webpage than a computing environment with better network, processing, and memory resources.

In one embodiment, the interface module 114 obtains the user computing environment characteristics data 131 from the web browser of the user. The web browser of the user can provide data indicating the network characteristics of the user computing environment, the processing resources of the user computing environment, and the memory resources of the user computing environment. For example, if the webpage utilizes a particular webpage encoding script, the webpage encoding script can have access to the various application programming interfaces (APIs) associated with the web browser and can obtain user computing environment characteristics data 131 from the various APIs. Additionally, or alternatively, the website service provider 112 can obtain user computing environment characteristics data 131 from sources other than the web browser of the user.

In one embodiment, the website server provider can make a decision to render the webpage on the server side if the user computing environment characteristics data 131 indicates that the user computing environment is insufficient to download and render the webpage. Accordingly, in some cases, the computing resources analysis model 118 can decide that a server associated with the website should render the webpage and then send the webpage data to the user to reduce the load on the user computing environment.

In one embodiment, as will be set forth in more detail below, the website service provider 112 utilizes the user computing environment characteristics data 131 to provide the personalized webpage access experience to the user.

In one embodiment, the website service provider 112 also receives user related data 132. The user related data 132 can include data provided directly by the user to the website service provider 112 via the interface module 114.

In one embodiment, the user related data 132 can include clickstream data indicating how the user has navigated through the website. The clickstream data can include data indicating which webpages the user has visited in the past. The clickstream data can include data indicating which aspects of the webpage the user has utilized in the past. Accordingly, the clickstream data can indicate the typical selections made and actions taken by the user as the user has navigated through the website in the past.

In one embodiment, the user related data 132 includes personal data about the user. The user related data can include a geolocation of the user, demographics information about the user, financial data related to the user, age data associated with the user, gender data associated with the user, a marital status associated with the user, a field of employment associated with the user, or other characteristics related to the user.

In one embodiment, when the interface module 114 receives webpage access request data 130, the website service provider 112 utilizes the user computing environment characteristics data 131 to determine whether the entirety of the webpage should be displayed to the user, or whether a reduced version of the webpage should be displayed to the user. If the website service provider 112 determines that the full webpage should be displayed to the user, and interface module 114 outputs full webpage content data 134 to the user. The full webpage content data 134 includes all of the data associated with the webpage. If the website service provider 112 determines that a reduced portion of the webpage of the displayed to the user, and interface module 114 outputs reduced webpage content data 136 retaining portions of the webpage data that are likely to be most relevant to the user and discarding the portions of the webpage data that are likely to be less relevant to the user. As will be set forth in more detail below, the website service provider 112 utilizes user related data 132 to determine which portions of the webpage data should be included in the reduced webpage content data 136.

In one embodiment, the website service provider 112 includes the website database 116. The website database 116 includes webpage data 138. The webpage data 138 includes the data for each webpage associated with the website. The webpage data 138 can include the full webpage content data 134 for each webpage associated with the website.

In one embodiment, the website service provider 112 utilizes the computing resources analysis model 118 to determine whether the full webpage content or reduced webpage content should be provided to the user. In particular, when the interface module 114 receives webpage access request data 130, and the user computing environment characteristics data 131 associated with the computing environment of the user is passed to the computing resources analysis model 118. The computing resources analysis model 118 analyzes the user computing environment characteristics data 131 in order to determine whether the full webpage content data 134 or the reduced webpage content data 136 should be provided to the user.

In one embodiment, the computing resources analysis model 118 analyzes the user computing environment characteristics data 131 in order to determine if the computing resources associated with the user computing environment of the user are sufficient to load the full webpage content data 134 within a selected period of time. If the computing resources of the user computing environments are sufficient to load the full webpage content data 134 within the selected period of time, then the computing resources analysis model 118 indicates to the interface module 114 that the full webpage content data 134 should be displayed. If the computing resources of the user computing environments are insufficient to load the full webpage content data within the selected period of time, in the computing resources analysis model 118 indicates to the interface module 114 that reduced webpage content data 136 should be displayed to the user.

In one embodiment, the computing resources analysis model 118 generates content reduction decision data 146 based on the analysis of the user computing environment characteristics data 131. The content reduction decision data 146 indicates the decision made by the computing resources analysis model 118 as to whether the full webpage content data 134 or reduced webpage content data 136 should be displayed to the user. The computing resources analysis model 118 can output the content reduction decision data 146 to the interface module 114 or to another module of the website service provider 112.

In one embodiment, the selected period of time is based on established performance benchmarks of the website service provider 112. In one example, the selected period of time is two seconds. In this case, the computing resources analysis model 118 determines whether the user computing environment is able to download, process, and display the full webpage content data 134 within two seconds. If the user computing environment is able to download, process, and display the full webpage content data 134 within two seconds, then the computing resources analysis model 118 generates content reduction decision data 146 indicating that the full webpage content data 134 should be provided to the user. If the user computing environments is not able to download, process, and display the full webpage content data 134 within two seconds, then the computing resources analysis model 118 generates content reduction decision data 146 indicating that reduced webpage content data 136 should be output to the user. Those of skill in the art will recognize, in light of the present disclosure, that other selected time periods can be used.

In one embodiment, the user computing environment characteristics data 131 includes user network connection data 140 the network connection of the user. The user network connection data 140 can include an identification of the Internet service provider (ISP) currently providing an Internet connection to the user.

In one embodiment, the user network connection data 140 can include data identifying the bandwidth associated with the network connection. The bandwidth can correspond to an amount of data per second the network connection is able to download and/or upload. A larger bandwidth is able to download or upload data more quickly. Accordingly, the bandwidth associated with a network can affect how quickly the user can download data associated with the webpage for which the user has provided webpage access request data.

In one embodiment, the user network connection data 140 can include network latency data. The network latency data can indicate the latency of the network, such as the magnitude of a delay that happens when data is communicated over the network. A lower latency network can provide faster communication than a higher latency network. Accordingly, the latency associated with a network can affect how quickly the user can download data associated with the webpage for which the user has provided webpage access request data.

In one embodiment, the user network connection data 140 includes an instantaneous bandwidth profile associated with the network connection of the user. The instantaneous bandwidth profile can indicate both latency and download bandwidth of the network connection. The network connection of the user can include an Internet connection.

In one embodiment, the user computing environment characteristics data 131 can include user processing resources data 142 indicating the processing resources of the user computing environment. For example, if the user requests to access a webpage from a desktop computer, a desktop computer typically has one or more processors associated therewith. The quality of the processer affects how quickly the user computing environment can process and load webpage data downloaded from the website service provider 112. Higher quality processors can process and load webpage data more quickly than can low quality processors. The user processing resources data 142 can include the manufacturer of the processors, the model number of the processors, a number of cores associated with the processors, a clock frequency associated with the processors, or other characteristics of the processors. Accordingly, the quality of the processing resources associated with the user computing environment can affect how quickly the user can download data associated with the webpage for which the user has provided webpage access request data.

In one embodiment, the user computing environment characteristics data 131 can include temperature data associated with the one or more processors of the user computing environment. Processors operating at higher temperatures may be taxed to the point that they cannot quickly process and load new webpage data. Accordingly, the temperature of the processors can affect how quickly the user computing environment can process and load webpage data associated with the webpage that the user is trying to access.

In one embodiment, the user computing environment characteristics data 131 can include user memory resources data 144 associated with the user computing environment. The user memory resources data 144 can include an amount of memory allocated to the web browser. The data related to the memory resources can include an amount of memory currently remaining for use by the web browser. The user memory resources data 144 can include amounts of memory associated with the one or more processors. The user memory resources data 144 can include amounts of RAM such as static random-access memory SRAM or dynamic random-access memory DRAM. The data related to the memory resources can include an amount is read only memory ROM associated with the computing environment of the user. The user memory resources data 144 can include access speeds associated with the memory various types of memories included in the computing environments.

In one embodiment, the computing resources analysis model 118 generates content reduction decision data 146 based on one or more of the user network connection data 140, the user processing resources data 142, and the user memory resources data 144. In one embodiment, the computing resources analysis model 118 can determine that reduced webpage content data 136 should be provided to the user based on a deficiency in any one of the network resources, processing resources, and memory resources associated with the user computing environment. In one embodiment, the computing resources analysis model 118 can determine that reduced webpage content data 136 should be provided to the user based on a collective deficiency of the network resources, processing resources, and memory resources of the user computing environment.

In one embodiment, the computing resources analysis model 118 is a part of the server that provides the webpage data to the user. In this case, the server that serves the webpage content data to the user makes the decision as to whether the full webpage content data 134 or the reduced webpage content data 136 should be provided to the user.

In one embodiment, the computing resources analysis model 118 can be at least partially included in code data provided to the web browser and related to the website associated with the website service provider 112. For example, there can be JavaScript associated with the website running in the web browser of the user. The JavaScript can include instructions for determining whether the full webpage content data 134 or the reduced webpage content data 136 should be provided to the user. Those of skill in the art will recognize, in light of the present disclosure, that other types of code can be running in the web browser and can determine whether the full webpage content data 134 or the reduced webpage content data 136 should be provided to the user.

In one embodiment, the website service provider 112 utilizes the content recommendation model 120 to determine what content should be included in the reduced webpage content data 136. In particular, when the computing resources analysis model 118 has determined that reduced webpage content data 136 should be provided to the user, the website service provider 112 makes a request to the content recommendation model 120 to determine what portion of the full webpage content data 134 should be included in the reduced webpage content data 136. The content recommendation model 120 determines what portions of the full webpage content data 134 are most likely to be relevant to the user and provides this information to the interface module 114.

In one embodiment, the content recommendation model 120 receives user related data 132. The user related data 132 includes data related to the characteristics or behavior of the user. The content recommendation model 120 analyzes the user related data 132 and generates recommended webpage content data 154. The recommended webpage content data 154 indicates the portions of the webpage data that are most likely to be relevant to the user. The interface module 114 outputs reduced webpage content data 136 based on the recommended webpage content data 154.

In one embodiment, the user related data 132 includes clickstream data 150. The clickstream data 150 indicates how the user has navigated through the website in the past. The clickstream data 150 can include data indicating which webpages the user has visited in the past. The clickstream data 150 can include data indicating which aspects of the webpage the user has utilized, viewed, or interacted with in the past. Accordingly, the clickstream data can indicate the typical selections made and actions taken by the user as the user has navigated through the website in the past.

In one example, in accordance with one embodiment, the website is a data management system website that assists users to manage their personal data. Users access the data management services to the website of the data management system. The clickstream data 150 can record, for each user, what features of the data management system website users and commonly used. For example, one webpage corresponding to a user's homepage. The homepage may include a dashboard that includes information and links associated with the user. The user may visit the webpage often, but typically only interacts with to do list feature provided on the dashboard. The user may typically ignore many other features displayed on the dashboard. The content recommendation model may recommend displaying the to do list but not displaying various other features that are typically not selected, viewed, or utilized by the user.

In one embodiment, when the user accesses the homepage, and the computing resources analysis model 118 determines that reduced webpage content data 136 should be provided to the user, the content recommendation model 120 can identify the top three features of the dashboard webpage that the user commonly interacts with. The content recommendation model 120 generates recommended webpage content data 154 indicating the three features of the dashboard with which the user commonly interacts. The interface module 114 outputs reduced webpage content data 136 including the top three features of the dashboard webpage and excluding other features of the dashboard webpage that are not commonly used.

In one embodiment, the user related data 132 includes personal data about the user. The user related data can include a geolocation of the user, demographics information about the user, financial data related to the user, age data associated with the user, gender data associated with the user, a marital status associated with the user, a field of employment associated with the user, or other characteristics related to the user.

In one embodiment, the content recommendation model 120 stores or has access to profile data 152. The profile data 152 includes profiles of various users of the website service provider 112. Each user can be fitted to one or more profiles based on various aspects of the user related data.

If a user visits a webpage for which the content recommendation model 120 does not have relevant clickstream data 150, the content recommendation model 120 can determine which profile or profiles the user belongs to and can access the clickstream data from other users that are similar to the user based on the profile or profiles. The content recommendation model 120 can generate recommended webpage content data 154 based on the clickstream data 150 of those users in the same profile or profiles as the current user.

In one example, a user from Cortez Colorado requests to access a webpage. The user is a 45-year-old married father of two children and is a small business owner. The content recommendation model identifies users that are similar to the user in terms of geolocation and demographics. The content recommendation model and analyzes the clickstream data of the similar users. The content recommendation model 120 can generate recommended webpage content data 154 for the user based on the clickstream data associated with the similar users. The interface module 114 outputs reduced webpage content data 136 to the user based on the recommended webpage content data 154.

In one embodiment, the recommended webpage content data 154 identifies features of a webpage that are most likely to be relevant to the user. The reduced webpage content data 136 may include these identified features and may not render features of the webpage not included in the list of features most likely to be relevant to the user.

In one embodiment, the recommended webpage content data 154 lists each feature of the webpage in order of relevance. The interface module 114 can output the reduced webpage content data 136 including a selected number of the most relevant features. The interface module 114 can determine whether or not to render features on how resource intensive it would be to render those features. Thus, a feature that is of borderline importance to the user but that is highly resource intensive to render, may not be included in the reduced webpage content data 136, while a feature of similar relevance but that is far less resource intensive may be included in the reduced webpage content data 136.

In one embodiment, the reduced webpage content data 136 can include leaving out text, video, graphics, hyperlinks, or other data that is included in the full webpage content data 134

In one embodiment, the interface module 114 can query the users as to whether they would rather receive reduced webpage content that is rendered quickly, or full webpage content that is rendered less quickly. The website service provider 112 records the responses of the users in the clickstream data 150. The website service provider 112 can make a decision to provide full webpage content data 134 or reduced webpage content data 136 based on this feedback. If a user has not provided such feedback, the content recommendation model 120 can identify whether users that are similar to the user have elected to receive reduced webpage content data 136, based on the profile data 152. The website service provider 112 can determine whether or not to provide reduced webpage content data 136 based on the preferences of the users that are similar to the user.

In one embodiment, the computing resources analysis model 118 is trained with a machine learning process to generate content reduction decision data 146. The machine learning process can include supervised and unsupervised machine learning processes. The machine learning process trains the computing resources analysis model 118 to receive as input the user computing environment characteristics data 131 and to output content reduction decisions data 146 based on the user computing environment characteristics data 131. In one embodiment, the computing resources analysis model 118 can include a decision tree model. Alternatively, the computing resources analysis model 118 can include other types of machine learning models.

In one embodiment, the content recommendation model 120 is trained with a machine learning process. In one embodiment, the content recommendation model 120 is trained with a supervised machine learning process. The supervised machine learning process can include utilizing training set data to train the content recommendation model 120. The training set data can include clickstream data 150 associated with a large number of users of the website service provider 112. The training set data can also include other user related attributes including geolocation, age, marital status, demographics, financial, or other kinds of data related to the users. The content recommendation model 120 is trained to identify, for a large number of webpages, which attributes of users predict various clickstream behaviors. The content recommendation model 120 is trained to identify aspects of the webpage that are most likely to be relevant to a user based on the user related data 132.

In one embodiment, during the machine learning process the content recommendation model 120 predicts whether the users would utilize various aspects of webpages. The content recommendation model 120 includes one or more mathematical functions or neural networks that cause the content recommendation model 120 to match the historical users to the aspects of webpages based on the characteristics of the historical users. During the machine learning process, these functions are iteratively adjusted, and the accuracy is checked. This process continues until the content recommendation model 120 can reliably reproduce the clickstream data based on the other attributes of the users.

In one embodiment, the content recommendation model 120 includes a Latent Dirichlet Allocation (LDA) model. In one embodiment, the content recommendation model 120 includes a naïve Bayes model. In one embodiment, the content recommendation model 120 includes logistic regression model. In one embodiment, the content recommendation model 120 includes a random forest model. In one embodiment, the predictive model includes a linear regression model. In one embodiment, the predictive model includes a linear discriminant model. In one embodiment, the predictive model includes a neural networks model. In one embodiment, the content recommendation model 120 includes a support vector machines model. In one embodiment, the predictive model includes a decision tree model. In one embodiment, the content recommendation model 120 includes a K nearest neighbors model. Additionally, or alternatively, the content recommendation model 120 can utilize other types of models or algorithms.

In one embodiment, the content recommendation model 120 includes both supervised and unsupervised machine learning. The unsupervised learning includes, in one embodiment, one or more of an LDA model, a probabilistic topic model, a clustering model, or other kinds of unsupervised learning. The supervised learning includes, in one embodiment, a multiclass classifier or another kind of supervised learning model.

In one embodiment, at content recommendation model 120 generates the profile data 152 by utilizing one or more grouping or clustering algorithms. In one embodiment, the one or more grouping or clustering algorithms include one or more of a k-means clustering algorithm, a density-based spatial clustering of applications with noise (DBSCAN) clustering algorithm, or an affinity propagation clustering algorithm. The stripping clustering algorithms can be utilized in the machine learning process.

In one embodiment, the content recommendation model 120 does not utilize machine learning to generate the recommended webpage content data 154. Instead, the content recommendation model 120 relies on the clickstream data 150 associated with the user, or the clickstream data associated with users that are similar to the user. The content recommendation model 120 is able to generate recommended webpage content data 154 by merely analyzing the clickstream data 150.

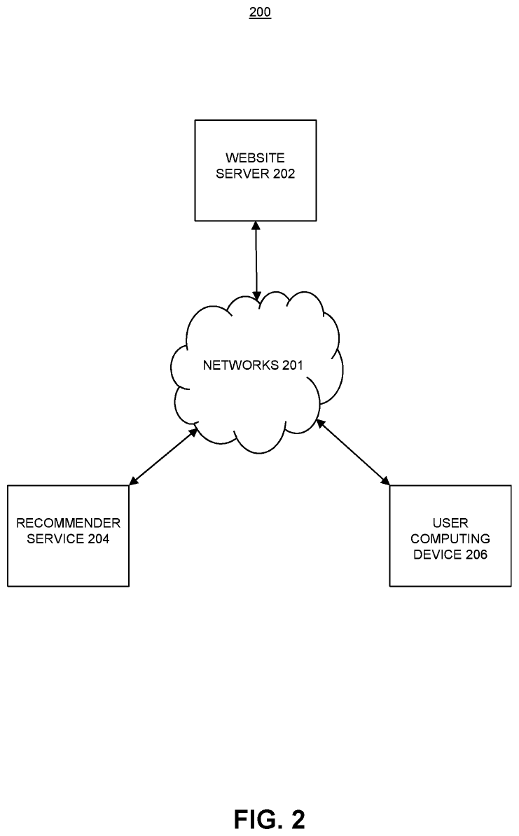

FIG. 2 is a block diagram of a system 200 for reducing and personalizing webpage content displayed to users based on the computing resources and personal characteristics of the user, in accordance with one embodiment. With reference to FIG. 1, FIG. 2, and the description of FIG. 1 above, the system 200 includes a website server 202, a recommender service 204, and a user computing device 206, according to various embodiments.

The website server 202, the recommender service 204, and the user computing device 206 are connected together via one or more networks 201. The networks 201 can include the Internet and other networks connected together in order to provide communication between the website server 202 and the user computing device 206, as well as between the website server 202 and the recommender service 204.

In one embodiment, the website server 202 includes one or more servers that enable the user operating the user computing device 206 to access various webpages associated with a website. The website server 202 can include the functionality of the interface module 114 and the computing resources analysis model 118 shown and FIG. 1 and described in relation to FIG. 1. The user computing device 206 can correspond to a user computing environment 160 shown in FIG. 1 and described in relation to FIG. 1. The recommender service 204 can include the content recommendation model 120 shown in FIG. 1 and described in relation to FIG. 1.

In one embodiment, a user, utilizing the user computing device 206, requests to access a webpage via the networks 201. The website server 202 receives the webpage access request and determines whether the computing resources associated with the user computing device 206 are sufficient to download and display the full webpage content associated with the webpage in a satisfactory amount of time. If the website server 202 determines that the computing resources associated with the user computing device 206 are sufficient to download and display the full webpage content associated with the webpage, the website server 202 serves the full webpage content data to the user computing device 206.

In one embodiment, if the website server 202 determines that the computing resources associated with the user computing device 206 are insufficient to download and display the full webpage content data in a satisfactory amount of time, then the website server 202 makes a request via the networks 201 to the recommender service 204. The recommender service 204 analyzes user data associated with the user and determines which content from the webpage is most likely relevant to the user. The recommender service 204 then provides to the website server 202 content recommendation data indicating which content from the webpage should be provided to the user. The website server 202 then provides reduced webpage content to the user computing device 206 via the networks 201 based on the content recommendation data provided by the recommender service 204.

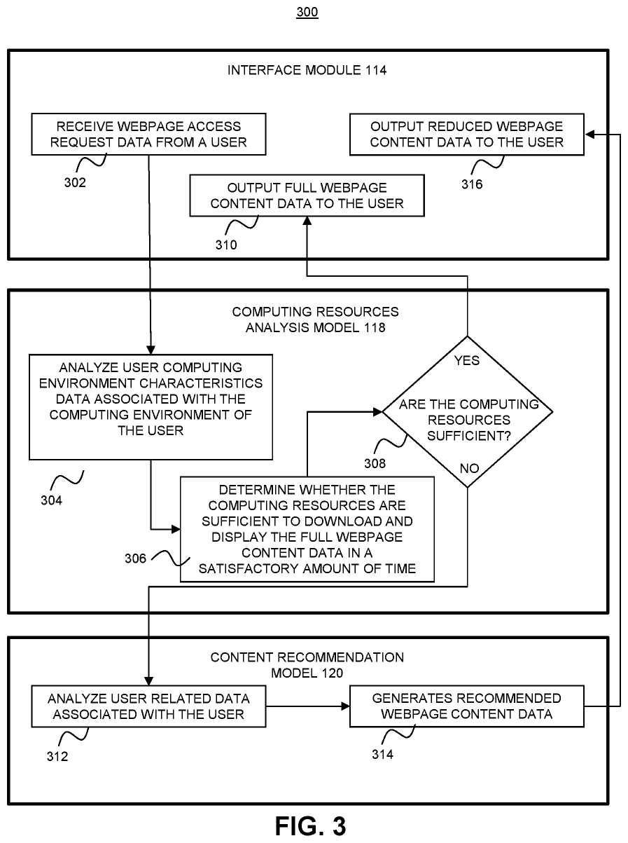

FIG. 3 illustrates a functional flow diagram of a process 300 for reducing and personalizing the webpage content displayed to users based on the computing resources and personal characteristics of the users, in accordance with one embodiment.

Referring to FIGS. 1-3 and the descriptions of FIGS. 1-2 above, at block 302, the interface module 114 receives webpage access request data from the user, using any of the methods, processes, and procedures discussed above with respect to FIGS. 1-2, according to one embodiment. From block 302, the process proceeds to block 304.

At block 304, the computing resources analysis model 118 analyzes the user computing environment characteristics data associated with the computing environment of the user, using any of the methods, processes, and procedures discussed above with respect to FIGS. 1-2, according to one embodiment. From block 304, the process proceeds to block 306.

At block 306, the computing resources analysis model 118 determines whether the computing resources are sufficient to download and display the full webpage content data in a satisfactory amount of time, using any of the methods, processes, and procedures discussed above with respect to FIGS. 1-2, according to one embodiment. From block 306, the process proceeds to block 308.

At block 308, if the computing resources are sufficient, then from block 308 the process proceeds to block 310, using any of the methods, processes, and procedures discussed above with respect to FIGS. 1-2, according to one embodiment.

At block 310, the interface module 114 outputs full webpage content data to the user, using any of the methods, processes, and procedures discussed above with respect to FIGS. 1-2, according to one embodiment. From block 310, the process proceeds to block 312.

At block 308, if the computing resources are not sufficient, then from block 308 the process proceeds to block 312, using any of the methods, processes, and procedures discussed above with respect to FIGS. 1-2, according to one embodiment.

At block 312, the content recommendation model 120 analyzes user related data associated with the user, using any of the methods, processes, and procedures discussed above with respect to FIGS. 1-2, according to one embodiment. From block 312, the process proceeds to block 314.

At block 314, the content recommendation model 120 generates recommended webpage content data, using any of the methods, processes, and procedures discussed above with respect to FIGS. 1-2, according to one embodiment. From block 314 the process proceeds to block 316.

At block 316 the interface module 114 outputs reduced webpage content data to the user, using any of the methods, processes, and procedures discussed above with respect to FIGS. 1-2, according to one embodiment.

Although a particular sequence is described herein for the execution of the process 300, other sequences can also be implemented, including fewer steps or more steps.

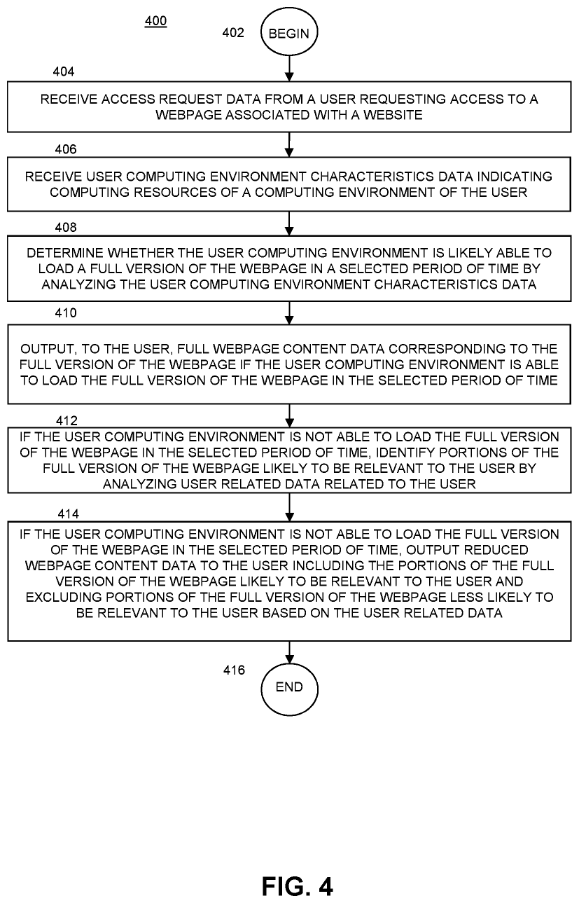

FIG. 4 illustrates a flow diagram of a process 400 for reducing and personalizing the webpage content displayed to users based on the computing resources and personal characteristics of the users, according to various embodiments.

Referring to FIGS. 1-3, and the description of FIGS. 1-3 above, in one embodiment, process 400 begins at BEGIN 402 and process flow proceeds to RECEIVE ACCESS REQUEST DATA FROM A USER REQUESTING ACCESS TO A WEBPAGE ASSOCIATED WITH A WEBSITE 404.

In one embodiment, at RECEIVE ACCESS REQUEST DATA FROM A USER REQUESTING ACCESS TO A WEBPAGE ASSOCIATED WITH A WEBSITE 404, access request data is received from a user requesting access to a webpage associated with a website, using any of the methods, processes, and procedures discussed above with respect to FIGS. 1-3.

In one embodiment, once access request data is received from a user requesting access to a webpage associated with a website at RECEIVE ACCESS REQUEST DATA FROM A USER REQUESTING ACCESS TO A WEBPAGE ASSOCIATED WITH A WEBSITE 404 process flow proceeds to RECEIVE USER COMPUTING ENVIRONMENT CHARACTERISTICS DATA INDICATING COMPUTING RESOURCES OF A COMPUTING ENVIRONMENT OF THE USER 406.

In one embodiment, at RECEIVE USER COMPUTING ENVIRONMENT CHARACTERISTICS DATA INDICATING COMPUTING RESOURCES OF A COMPUTING ENVIRONMENT OF THE USER 406, user computing environment characteristics data is received indicating computing resources of a computing environment of the user, using any of the methods, processes, and procedures discussed above with respect to FIGS. 1-3.

In one embodiment, once user computing environment characteristics data is received indicating computing resources of a computing environment of the user at RECEIVE USER COMPUTING ENVIRONMENT CHARACTERISTICS DATA INDICATING COMPUTING RESOURCES OF A COMPUTING ENVIRONMENT OF THE USER 406, process flow proceeds to DETERMINE WHETHER THE USER COMPUTING ENVIRONMENT IS ABLE TO LOAD A FULL VERSION OF THE WEBPAGE IN A SELECTED PERIOD OF TIME BY ANALYZING THE USER COMPUTING ENVIRONMENT CHARACTERISTICS DATA 408.

In one embodiment, at DETERMINE WHETHER THE USER COMPUTING ENVIRONMENT IS ABLE TO LOAD A FULL VERSION OF THE WEBPAGE IN A SELECTED PERIOD OF TIME BY ANALYZING THE USER COMPUTING ENVIRONMENT CHARACTERISTICS DATA 408, it is determined whether the user computing environment is able to load a full version of the webpage in a selected period of time by analyzing the user computing environment characteristics data, using any of the methods, processes, and procedures discussed above with respect to FIGS. 1-3.

In one embodiment, once it is determined whether the user computing environment is able to load a full version of the webpage in a selected period of time by analyzing the user computing environment characteristics data at DETERMINE WHETHER THE USER COMPUTING ENVIRONMENT IS ABLE TO LOAD A FULL VERSION OF THE WEBPAGE IN A SELECTED PERIOD OF TIME BY ANALYZING THE USER COMPUTING ENVIRONMENT CHARACTERISTICS DATA 408, process flow proceeds to OUTPUT, TO THE USER, FULL WEBPAGE CONTENT DATA CORRESPONDING TO THE FULL VERSION OF THE WEBPAGE IF THE USER COMPUTING ENVIRONMENT IS ABLE TO LOAD THE FULL VERSION OF THE WEBPAGE IN THE SELECTED PERIOD OF TIME 410.

In one embodiment, at OUTPUT, TO THE USER, FULL WEBPAGE CONTENT DATA CORRESPONDING TO THE FULL VERSION OF THE WEBPAGE IF THE USER COMPUTING ENVIRONMENT IS ABLE TO LOAD THE FULL VERSION OF THE WEBPAGE IN THE SELECTED PERIOD OF TIME 410, full webpage content data is output to the user corresponding to the full version of the webpage if the user computing environment is able to load the full version of the webpage in the selected period of time, using any of the methods, processes, and procedures discussed above with respect to FIGS. 1-3.

In one embodiment, once full webpage content data is output to the user corresponding to the full version of the webpage if the user computing environment is able to load the full version of the webpage in the selected period of time at OUTPUT, TO THE USER, FULL WEBPAGE CONTENT DATA CORRESPONDING TO THE FULL VERSION OF THE WEBPAGE IF THE USER COMPUTING ENVIRONMENT IS ABLE TO LOAD THE FULL VERSION OF THE WEBPAGE IN THE SELECTED PERIOD OF TIME 410, process flow proceeds to IF THE USER COMPUTING ENVIRONMENT IS NOT ABLE TO LOAD THE FULL VERSION OF THE WEBPAGE IN THE SELECTED PERIOD OF TIME, IDENTIFY PORTIONS OF THE FULL VERSION OF THE WEBPAGE LIKELY TO BE RELEVANT TO THE USER BY ANALYZING USER RELATED DATA RELATED TO THE USER 412.

In one embodiment, at IF THE USER COMPUTING ENVIRONMENT IS NOT ABLE TO LOAD THE FULL VERSION OF THE WEBPAGE IN THE SELECTED PERIOD OF TIME, IDENTIFY PORTIONS OF THE FULL VERSION OF THE WEBPAGE LIKELY TO BE RELEVANT TO THE USER BY ANALYZING USER RELATED DATA RELATED TO THE USER 412, if the user computing environment is not able to load the full version of the webpage in the selected period of time, portions of the full version of the webpage are identified that are likely to be relevant to the user by analyzing user related data related to the user, using any of the methods, processes, and procedures discussed above with respect to FIGS. 1-3.

In one embodiment, once if the user computing environment is likely not able to load the full version of the webpage in the selected period of time, portions of the full version of the webpage are identified that are likely to be relevant to the user by analyzing user related data related to the user at IF THE USER COMPUTING ENVIRONMENT IS NOT ABLE TO LOAD THE FULL VERSION OF THE WEBPAGE IN THE SELECTED PERIOD OF TIME, IDENTIFY PORTIONS OF THE FULL VERSION OF THE WEBPAGE LIKELY TO BE RELEVANT TO THE USER BY ANALYZING USER RELATED DATA RELATED TO THE USER 412, process flow proceeds to IF THE USER COMPUTING ENVIRONMENT IS NOT ABLE TO LOAD THE FULL VERSION OF THE WEBPAGE IN THE SELECTED PERIOD OF TIME, OUTPUT REDUCED WEBPAGE CONTENT DATA TO THE USER INCLUDING THE PORTIONS OF THE FULL VERSION OF THE WEBPAGE LIKELY TO BE RELEVANT TO THE USER AND EXCLUDING PORTIONS OF THE FULL VERSION OF THE WEBPAGE LESS LIKELY TO BE RELEVANT TO THE USER BASED ON THE USER RELATED DATA 414.

In one embodiment, at IF THE USER COMPUTING ENVIRONMENT IS NOT ABLE TO LOAD THE FULL VERSION OF THE WEBPAGE IN THE SELECTED PERIOD OF TIME, OUTPUT REDUCED WEBPAGE CONTENT DATA TO THE USER INCLUDING THE PORTIONS OF THE FULL VERSION OF THE WEBPAGE LIKELY TO BE RELEVANT TO THE USER AND EXCLUDING PORTIONS OF THE FULL VERSION OF THE WEBPAGE LESS LIKELY TO BE RELEVANT TO THE USER BASED ON THE USER RELATED DATA 414, if the user computing environment is not able to load the full version of the webpage in the selected period of time, reduced webpage content data is output to the user including the portions of the full version of the webpage likely to be relevant to the user and excluding portions of the full version of the webpage less likely to be relevant to the user based on the user related data, using any of the methods, processes, and procedures discussed above with respect to FIGS. 1-3.

In one embodiment, once if the user computing environment is not able to load the full version of the webpage in the selected period of time, reduced webpage content data is output to the user including the portions of the full version of the webpage likely to be relevant to the user and excluding portions of the full version of the webpage less likely to be relevant to the user based on the user related data at IF THE USER COMPUTING ENVIRONMENT IS NOT ABLE TO LOAD THE FULL VERSION OF THE WEBPAGE IN THE SELECTED PERIOD OF TIME, OUTPUT REDUCED WEBPAGE CONTENT DATA TO THE USER INCLUDING THE PORTIONS OF THE FULL VERSION OF THE WEBPAGE LIKELY TO BE RELEVANT TO THE USER AND EXCLUDING PORTIONS OF THE FULL VERSION OF THE WEBPAGE LESS LIKELY TO BE RELEVANT TO THE USER BASED ON THE USER RELATED DATA 414, process flow proceeds to END 416.

In one embodiment, at END 416 the process for reducing and personalizing the webpage content displayed to users based on the computing resources and personal characteristics of the users is exited to await new data and/or instructions.

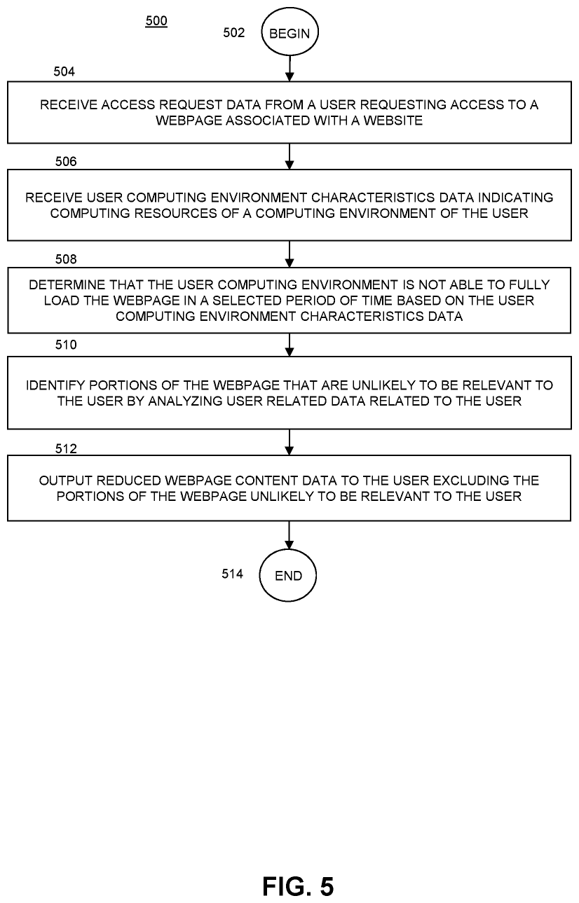

FIG. 5 illustrates a flow diagram of a process 500 for reducing and personalizing the webpage content displayed to users based on the computing resources and personal characteristics of the users, according to various embodiments.

Referring to FIGS. 1-3, 5 and the description of FIGS. 1-3 above, in one embodiment, process 500 begins at BEGIN 502 and process flow proceeds to RECEIVE ACCESS REQUEST DATA FROM A USER REQUESTING ACCESS TO A WEBPAGE ASSOCIATED WITH A WEBSITE 504.

In one embodiment, at RECEIVE ACCESS REQUEST DATA FROM A USER REQUESTING ACCESS TO A WEBPAGE ASSOCIATED WITH A WEBSITE 504, access request data is received from a user requesting access to a webpage associated with a website, using any of the methods, processes, and procedures discussed above with respect to FIGS. 1-3.

In one embodiment, once access request data is received from a user requesting access to a webpage associated with a website at RECEIVE ACCESS REQUEST DATA FROM A USER REQUESTING ACCESS TO A WEBPAGE ASSOCIATED WITH A WEBSITE 504 process flow proceeds to RECEIVE USER COMPUTING ENVIRONMENT CHARACTERISTICS DATA INDICATING COMPUTING RESOURCES OF A COMPUTING ENVIRONMENT OF THE USER 506.

In one embodiment, at RECEIVE USER COMPUTING ENVIRONMENT CHARACTERISTICS DATA INDICATING COMPUTING RESOURCES OF A COMPUTING ENVIRONMENT OF THE USER 506, user computing environment characteristics data is received indicating computing resources of a computing environment of the user, using any of the methods, processes, and procedures discussed above with respect to FIGS. 1-3.

In one embodiment, once user computing environment characteristics data is received indicating computing resources of a computing environment of the user at RECEIVE USER COMPUTING ENVIRONMENT CHARACTERISTICS DATA INDICATING COMPUTING RESOURCES OF A COMPUTING ENVIRONMENT OF THE USER 506, process flow proceeds to DETERMINE THAT THE USER COMPUTING ENVIRONMENT IS NOT ABLE TO FULLY LOAD THE WEBPAGE IN A SELECTED PERIOD OF TIME BASED ON THE USER COMPUTING ENVIRONMENT CHARACTERISTICS DATA 508.

In one embodiment, at DETERMINE THAT THE USER COMPUTING ENVIRONMENT IS NOT ABLE TO FULLY LOAD THE WEBPAGE IN A SELECTED PERIOD OF TIME BASED ON THE USER COMPUTING ENVIRONMENT CHARACTERISTICS DATA 508, it is determined that the user computing environment is not able to fully load the webpage in a selected period of time based on the user computing environment characteristics data, using any of the methods, processes, and procedures discussed above with respect to FIGS. 1-3.

In one embodiment, once it is determined that the user computing environment is not able to fully load the webpage in a selected period of time based on the user computing environment characteristics data at DETERMINE THAT THE USER COMPUTING ENVIRONMENT IS NOT ABLE TO FULLY LOAD THE WEBPAGE IN A SELECTED PERIOD OF TIME BASED ON THE USER COMPUTING ENVIRONMENT CHARACTERISTICS DATA 508, process flow proceeds to IDENTIFY PORTIONS OF THE WEBPAGE THAT ARE UNLIKELY TO BE RELEVANT TO THE USER BY ANALYZING USER RELATED DATA RELATED TO THE USER 510.

In one embodiment, at IDENTIFY PORTIONS OF THE WEBPAGE THAT ARE UNLIKELY TO BE RELEVANT TO THE USER BY ANALYZING USER RELATED DATA RELATED TO THE USER 510, portions of the webpage are identified that are unlikely to be relevant to the user by analyzing user related data related to the user, using any of the methods, processes, and procedures discussed above with respect to FIGS. 1-3.

In one embodiment, once portions of the webpage are identified that are unlikely to be relevant to the user by analyzing user related data related to the user at IDENTIFY PORTIONS OF THE WEBPAGE THAT ARE UNLIKELY TO BE RELEVANT TO THE USER BY ANALYZING USER RELATED DATA RELATED TO THE USER 510, process flow proceeds to OUTPUT REDUCED WEBPAGE CONTENT DATA TO THE USER EXCLUDING THE PORTIONS OF THE WEBPAGE UNLIKELY TO BE RELEVANT TO THE USER 512.

In one embodiment, at OUTPUT REDUCED WEBPAGE CONTENT DATA TO THE USER EXCLUDING THE PORTIONS OF THE WEBPAGE UNLIKELY TO BE RELEVANT TO THE USER 512, reduced webpage content data is output to the user excluding the portions of the webpage unlikely to be relevant to the user using any of the methods, processes, and procedures discussed above with respect to FIGS. 1-3.

In one embodiment, once reduced webpage content data is output to the user excluding the portions of the webpage unlikely to be relevant to the user at OUTPUT REDUCED WEBPAGE CONTENT DATA TO THE USER EXCLUDING THE PORTIONS OF THE WEBPAGE UNLIKELY TO BE RELEVANT TO THE USER 512, process flow proceeds to END 514.

In one embodiment, at END 514 the process for reducing and personalizing the webpage content displayed to users based on the computing resources and personal characteristics of the users is exited to await new data and/or instructions.

As noted above, the specific illustrative examples discussed above are but illustrative examples of implementations of embodiments of the method or process for reducing and personalizing the webpage content displayed to users based on the computing resources and personal characteristics of the users. Those of skill in the art will readily recognize that other implementations and embodiments are possible. Therefore, the discussion above should not be construed as a limitation on the claims provided below.

In one embodiment, a computing system implemented method reduces and personalizes the webpage content displayed to users based on the computing resources and personal characteristics of the users. The method includes receiving access request data from a user requesting access to a webpage associated with a website, receiving user computing environment characteristics data indicating computing resources of a computing environment of the user, and determining whether the user computing environment is able to load a full version of the webpage in a selected period of time by analyzing the user computing environment characteristics data. The method includes outputting, to the user, full webpage content data corresponding to the full version of the webpage if the user computing environment is able to load the full version of the webpage in the selected period of time and if the user computing environment is not able to load the full version of the webpage in the selected period of time, identifying portions of the full version of the webpage likely to be relevant to the user by analyzing user related data related to the user. The method includes if the user computing environment is not able to load the full version of the webpage in the selected period of time, outputting reduced webpage content data to the user including the portions of the full version of the webpage likely to be relevant to the user and excluding portions of the full version of the webpage less likely to be relevant to the user based on the user related data.

In one embodiment, a system for reducing and personalizing the webpage content displayed to users based on the computing resources and personal characteristics of the users includes at least one processor and at least one memory coupled to the at least one processor. The at least one memory has stored therein instructions which, when executed by any set of the one or more processors, perform a process. The process includes receiving access request data from a user requesting access to a webpage associated with a website, receiving user computing environment characteristics data indicating computing resources of a computing environment of the user, and determining whether the user computing environment is able to load a full version of the webpage in a selected period of time by analyzing the user computing environment characteristics data. The process includes outputting, to the user, full webpage content data corresponding to the full version of the webpage if the user computing environment is able to load the full version of the webpage in the selected period of time and if the user computing environment is not able to load the full version of the webpage in the selected period of time, identifying portions of the full version of the webpage likely to be relevant to the user by analyzing user related data related to the user. The process includes if the user computing environment is not able to load the full version of the webpage in the selected period of time, outputting reduced webpage content data to the user including the portions of the full version of the webpage likely to be relevant to the user and excluding portions of the full version of the webpage less likely to be relevant to the user based on the user related data.

In one embodiment, a computing system implemented method reduces and personalizes the webpage content displayed to users based on the computing resources and personal characteristics of the users. The method includes receiving access request data from a user requesting access to a webpage associated with a website, receiving user computing environment characteristics data indicating computing resources of a computing environment of the user, determining that the user computing environment is not able to fully load the webpage in a selected period of time based on the user computing environment characteristics data, identifying portions of the webpage that are unlikely to be relevant to the user by analyzing user related data related to the user, and outputting reduced webpage content data to the user excluding the portions of the webpage unlikely to be relevant to the user.

In one embodiment, a system for reducing and personalizing the webpage content displayed to users based on the computing resources and personal characteristics of the users includes at least one processor and at least one memory coupled to the at least one processor. The at least one memory has stored therein instructions which, when executed by any set of the one or more processors, perform a process. The process includes receiving access request data from a user requesting access to a webpage associated with a website, receiving user computing environment characteristics data indicating computing resources of a computing environment of the user, determining that the user computing environment is not able to fully load the webpage in a selected period of time based on the user computing environment characteristics data, identifying portions of the webpage that are unlikely to be relevant to the user by analyzing user related data related to the user, and outputting reduced webpage content data to the user excluding the portions of the webpage unlikely to be relevant to the user.

In one embodiment, a computing system implemented method reduces and personalizes the webpage content displayed to users based on the computing resources and personal characteristics of the users. The method includes receiving access request data from a user requesting access to a webpage associated with a website, receiving user computing environment characteristics data indicating computing resources of a computing environment of the user, and determining whether the user computing environment is able to load the webpage in a selected period of time by analyzing the user computing environment characteristics data. The method includes outputting, to the user, full webpage content data if the user computing environment is able to load the webpage in the selected period of time, if the user computing environment is not able to load the webpage in the selected period of time, identifying portions of the webpage likely to be relevant to the user by analyzing user related data related to the user, and if the user computing environment is not able to load the in the selected period of time, outputting reduced webpage content data to the user including the portions of the webpage likely to be relevant to the user and excluding portions of the webpage less likely to be relevant to the user based on the user related data.

In one embodiment, a system for reducing and personalizing the webpage content displayed to users based on the computing resources and personal characteristics of the users includes at least one processor and at least one memory coupled to the at least one processor. The at least one memory has stored therein instructions which, when executed by any set of the one or more processors, perform a process. The process includes receiving access request data from a user requesting access to a webpage associated with a website, receiving user computing environment characteristics data indicating computing resources of a computing environment of the user, and determining whether the user computing environment is able to load the webpage in a selected period of time by analyzing the user computing environment characteristics data. The process includes outputting, to the user, full webpage content data if the user computing environment is able to load the webpage in the selected period of time, if the user computing environment is not able to load the webpage in the selected period of time, identifying portions of the webpage likely to be relevant to the user by analyzing user related data related to the user, and if the user computing environment is not able to load the in the selected period of time, outputting reduced webpage content data to the user including the portions of the webpage likely to be relevant to the user and excluding portions of the webpage less likely to be relevant to the user based on the user related data.

The disclosed embodiments provide one or more technical solutions to the technical problem of providing a website that loads quickly for all user and maintain high quality. These and other embodiments of the website service provider are discussed in further detail below.

The disclosed embodiments provide one or more technical solutions to the technical problem of providing a website that loads quickly for all user and maintain high quality. These and other embodiments of the website service provider are discussed in further detail below.

Reducing and personalizing the webpage content displayed to users based on the computing resources and personal characteristics of the users does not constitute an abstract idea, but rather represents a technical solution to a technical problem of website service providers that are unable to effectively reduce and personalize the webpage content displayed to users based on the computing resources and personal characteristics of the users. First, reducing and personalizing the webpage content displayed to users based on the computing resources and personal characteristics of the users is not an abstract idea because it is not merely an idea itself (e.g., can be performed mentally or using pen and paper). Second, reducing and personalizing the webpage content displayed to users based on the computing resources and personal characteristics of the users is not an abstract idea because it is not a fundamental economic practice (e.g., is not merely creating a contractual relationship, hedging, mitigating a settlement risk, etc.). Third, reducing and personalizing the webpage content displayed to users based on the computing resources and personal characteristics of the users is not an abstract idea because it is not a method of organizing human activity (e.g., managing a game of bingo). Fourth, although mathematics may be used to generate an analytics analysis model, the disclosed and claimed methods and systems of reducing and personalizing the webpage content displayed to users based on the computing resources and personal characteristics of the users are not an abstract idea because the methods and systems are not simply a mathematical relationship/formula.

As a result, embodiments of the present disclosure allow for reduced use of processor cycles, memory, and power consumption, by reducing the amount of data transmitted to slower computing systems. Consequently, computing and communication systems implementing or providing the embodiments of the present disclosure are transformed into more operationally efficient devices and systems.

In addition to improving overall computing performance, reducing and personalizing the webpage content displayed to users based on the computing resources and personal characteristics of the users improves the field of web development by reducing the amount of time it takes for a webpage to load, according to one embodiment. Therefore, both human and non-human resources are utilized more efficiently. Furthermore, by assisting experts associated with a website service provider to improve the effectiveness of their profiles, loyalty in the website service provider is increased. This results in repeat customers, efficient web services delivery, and reduced abandonment of use of the website service provider, according to one embodiment.

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as one or more virtual assets.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system.

As used herein, the term “relationship(s)” includes, but is not limited to, a logical, mathematical, statistical, or other association between one set or group of information, data, and/or users and another set or group of information, data, and/or users, according to one embodiment. The logical, mathematical, statistical, or other association (i.e., relationship) between the sets or groups can have various ratios or correlation, such as, but not limited to, one-to-one, multiple-to-one, one-to-multiple, multiple-to-multiple, and the like, according to one embodiment. As a non-limiting example, if the disclosed system and method for providing access control and enhanced encryption determines a relationship between a first group of data and a second group of data, then a characteristic or subset of a first group of data can be related to, associated with, and/or correspond to one or more characteristics or subsets of the second group of data, or vice-versa, according to one embodiment. Therefore, relationships may represent one or more subsets of the second group of data that are associated with one or more subsets of the first group of data, according to one embodiment. In one embodiment, the relationship between two sets or groups of data includes, but is not limited to similarities, differences, and correlations between the sets or groups of data.

As used herein, the term storage container includes, but is not limited to, any physical or virtual data source or storage device. For instance, in various embodiments, a storage container can be, but is not limited to, one or more of a hard disk drive, a solid-state drive, an EEPROM, an optical disk, a server, a memory array, a database, a virtual database, a virtual memory, a virtual data directory, or other physical or virtual data sources.

As used herein, the term application container includes, but is not limited to, one or more profiles or other data sets that allow users and processes to access only particular data within a file system related to a storage container. For instance, in various embodiments, an application container can include, but is not limited to, a set of rules, a list of files, a list of processes, and/or encryption keys that provide access control to a file system such that a user associated with the application container can only access data, files, objects or other portions of a file system in accordance with the set of rules, the list of files, the list of processes, and/or encryptions keys.

As used herein, the term file includes, but is not limited to, a data entity that is a sequence of bytes that can be accessed individually or collectively.

As used herein the term data object includes, but is not limited to, a data entity that is stored and retrieved as a whole, or in large chunks, rather than as a sequence of bytes.

As used herein, the term “account” includes, but is not limited to, a grouping of transactions within an accounting system. For instance, in various embodiments, accounts can be hierarchical in that one account can contain the content of one or more other accounts. Apart for hierarchical nesting accounts may also be structured to be either mutually exclusive or not mutually exclusive such that if there is a containment relationship between two accounts the containment may either be complete or partial.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general-purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general-purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for reducing and personalizing the webpage content displayed to users based on the computing resources and personal characteristics of the users, the method comprising:
receiving access request data from a user requesting access to a webpage associated with a website;
receiving user computing environment characteristics data indicating computing resources of a computing environment of the user;
determining whether the user computing environment is able to load a full version of the webpage in a selected period of time by analyzing the user computing environment characteristics data;
outputting, to the user, full webpage content data corresponding to the full version of the webpage if the user computing environment is able to load the full version of the webpage in the selected period of time;
if the user computing environment is not able to load the full version of the webpage in the selected period of time, identifying portions of the full version of the webpage likely to be relevant to the user by analyzing user related data related to the user; and
if the user computing environment is not able to load the full version of the webpage in the selected period of time, outputting reduced webpage content data to the user including the portions of the full version of the webpage likely to be relevant to the user and excluding portions of the full version of the webpage less likely to be relevant to the user based on the user related data.

2. The method of claim 1, wherein the user computing environment characteristics data includes user network connection data indicating characteristics of a network connection of the user computing environment.

3. The method of claim 2, wherein the user network connection data indicates a bandwidth of the network connection.

4. The method of claim 3, wherein the user network connection data indicates a network latency of the network connection.

5. The method of claim 2, wherein determining whether the user computing environment is able to load the full version of the webpage includes determining whether the network connection of the user computing environment is sufficient to fully download the full version of the webpage in the selected period of time.

6. The method of claim 1, wherein the user computing environment characteristics data includes user processing resources data indicating characteristics of processing resources of the user computing environment.

7. The method of claim 1, wherein user computing environment characteristics data includes user memory resources data indicating characteristics of memory resources of the user computing environment.

8. The method of claim 1, wherein receiving the user computing environment characteristics data includes receiving the user computing environment characteristics data from an application programming interface of a web browser operating in the user computing environment.

9. The method of claim 1, wherein the user related data includes clickstream data indicating how the user has navigated the website in the past.

10. The method of claim 9, wherein identifying portions of the full version of the webpage likely to be relevant to the user includes identifying portions of the full version of the webpage that the user has interacted with in the past based on the clickstream data.

11. The method of claim 1, wherein the user related data includes one or more of:
demographics data associated with the user;
geolocation data associated with the user;
financial data associated with the user;
age data associated with the user;
gender data associated with the user; and
household data associated with the user.

12. The method of claim 1, wherein identifying portions of the full version of the webpage likely to be relevant to the user includes identifying other users similar to the user based on the user related data and identifying portions of the full version of the webpage likely to be relevant to the other users based on clickstream data associated with the other users.

13. The method of claim 1, wherein identifying portions of full version of the webpage likely to be relevant to the user includes utilizing a content recommendation model.

14. The method of claim 13, further comprising training the content recommendation model with a machine learning process to identify portions of webpages likely to be relevant to users based on user related data associated with the user.

15. A computing system implemented method for reducing and personalizing the webpage content displayed to users based on the computing resources and personal characteristics of the users, the method comprising:
receiving access request data from a user requesting access to a webpage associated with a website;
receiving user computing environment characteristics data indicating computing resources of a computing environment of the user;
determining that the user computing environment is not able to fully load the webpage in a selected period of time based on the user computing environment characteristics data;
identifying portions of the webpage that are unlikely to be relevant to the user by analyzing user related data related to the user; and
outputting reduced webpage content data to the user excluding the portions of the webpage unlikely to be relevant to the user.

16. The method of claim 15, wherein excluding the portions of the webpage include excluding one or more of:
text included in a full version of the webpage;
graphics included in a full version of the webpage;
video included in a full version of the webpage; and
audio included in a full version of the webpage.

17. The method of claim 15, wherein the website is a data management website that provides, to users of the website, one or more of:
electronic bookkeeping services;
electronic tax return preparation services; and
electronic financial management services.

18. The method of claim 15, wherein the user computing environment characteristics data includes user network connection data indicating characteristics of a network connection of the user computing environment.

19. The method of claim 18, wherein determining whether the user computing environment is able to fully load the webpage includes determining whether the network connection of the user computing environment is sufficient to fully download the webpage in the selected period of time.

20. A system for reducing and personalizing the webpage content displayed to users based on the computing resources and personal characteristics of the users, the system comprising:
at least one processor; and
at least one memory coupled to the at least one processor, the at least one memory having stored therein instructions which, when executed by any set of the one or more processors, perform a process including:
receiving access request data from a user requesting access to a webpage associated with a website;
receiving user computing environment characteristics data indicating computing resources of a computing environment of the user;
determining whether the user computing environment is able to load the webpage in a selected period of time by analyzing the user computing environment characteristics data;
outputting, to the user, full webpage content data if the user computing environment is able to load the webpage in the selected period of time;
if the user computing environment is not able to load the webpage in the selected period of time, identifying portions of the webpage likely to be relevant to the user by analyzing user related data related to the user; and
if the user computing environment is not able to load the webpage in the selected period of time, outputting reduced webpage content data to the user including the portions of the webpage likely to be relevant to the user and excluding portions of the webpage less likely to be relevant to the user based on the user related data.

21. The process of claim 20, wherein the user computing environment characteristics data includes user network connection data indicating characteristics of a network connection of the user computing environment.

22. The process of claim 21, wherein the user network connection data indicates a bandwidth of the network connection.

23. The process of claim 22, wherein the user network connection data indicates a network latency of the network connection.

24. The process of claim 21, wherein determining whether the user computing environment is able to load the full version of the webpage includes determining whether the network connection of the user computing environment is sufficient to fully download the full version of the webpage in the selected period of time.

25. The process of claim 20, wherein receiving the user computing environment characteristics data includes receiving the user computing environment characteristics data from an application programming interface of a web browser operating in the user computing environment.

26. The process of claim 20, wherein the user related data includes clickstream data indicating how the user has navigated the website in the past.

27. The process of claim 26, wherein identifying portions of the full version of the webpage likely to be relevant to the user includes identifying portions of the full version of the webpage that the user has interacted with in the past based on the clickstream data.

28. The process of claim 20, wherein excluding the portions of the webpage include excluding one or more of:
text included in a full version of the webpage;
graphics included in a full version of the webpage;
video included in a full version of the webpage; and
audio included in a full version of the webpage.

29. The process of claim 20, wherein if the user computing environment is not able to load the webpage in the selected period of time, rendering a portion of the webpage on a server of the website service provider before outputting the reduced webpage content data to the user.
